(19) United States
(12) Patent Application Publication
(10) Pub. No.: US 2003/0000887 A1
(43) Pub. Date: Jan. 2, 2003

(54) Filter rite

(76) Inventor: Melody Sue Zaske, Janesville, WI (US)

Correspondence Address: MELODY SUE ZASKE, 614 WEST RACING STREET, JANESVILLE, WI, 53545, US

(21) Appl. No.: 09/897,376

(22) Filed: Jul. 2, 2001

(51) Int. Cl. B01D 35/02

(52) U.S. Cl. 210/464; 210/473; 210/482

(57) ABSTRACT

A new Invention, Filter Rite, would provide an innovative alternative to conventional coffee filters in the form of a reusable coffee filter designed for use in a percolator coffee pot. It would be ideal for owners of percolator coffee pots and would allow coffee drinks to save time, money and effort. In addition Filter Rite would be produced from high-quality, durable materials and could be easily stored when not in use. Filter Rite would be marketed to virtually all households. Possible secondary markets would be hotels, motels and restaurants.

Plastics would be main componet using Injection molding or Blow molding, filtration parts would either be a fine plastic mesh or fine cooper mesh.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

Coffee is an extremely popular beverage among many people. Some choose to go to a coffee bar and purchase specially made coffees such as a latte, a cappuccino or an espresso. Others prefer to brew their own coffee at home with a coffeemaker machine or a percolator coffee pot.

However, using a percolator coffee pot can have minor drawbacks on occasion. This type of coffee pot requires the use of disposable filters along with the original filter that comes with the coffeemaker. These filters must be purchased at a supermarket, supplying these filters on a regular basis can be both time-consuming and expensive, especially if one is a habitual coffee drinker.

Filter Rite, would provide an innovative alternative to conventional coffee filters in the form of a reusable coffee filter designed for use in a percolator coffee pot. It would be ideal for owners of Percolator coffee pots and would allow coffee drinkers to save time, money and effort. In addition, Filter Rite would be produce from hiqh-quality, durable materials and could be easily stored when not in use.

Filter Rite would be marketed to virtually all house-holds and secondary markets would be hotels, motels, restaurants and hospitals.

### BRIEF SUMMARY OF THE INVENTION

A new Invention, Filter Rite, would provide a reusable coffee filter, you buy it once and wash it and use it over and over. It would replace the paper filters that are used today. It's fast, easy to use and clean up is a breeze.

### BRIEF DESCRIPTION OF THE SEVERAL VIEWS OF THE DRAWING

FIG. 1. Side view of Filter Rite, you can see how coffee would brew through flow tube and then through side panels.

FIG. 2. Top view of Filter Rite, the flow tube is centered and this is where the coffee flows and then is filtered through the side and bottom panels.

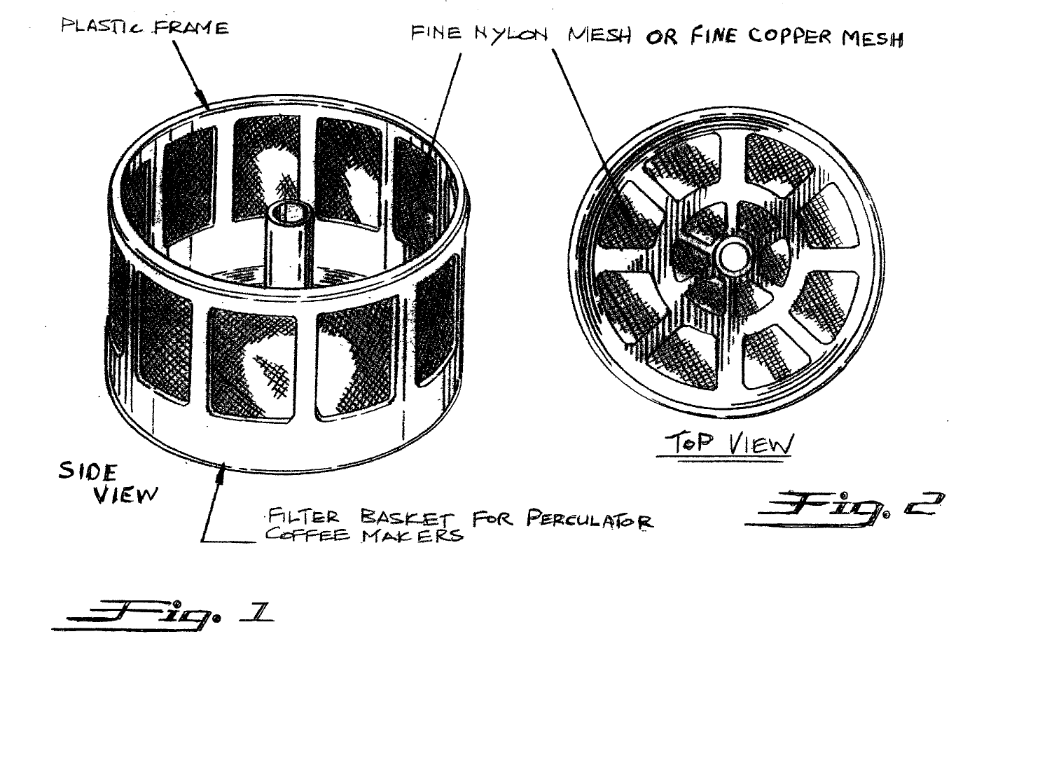

The filter would have a solid brown plastic top measuring one-sixteenth of an inch in width, a brown central flow tube measuring one and three-fourth inches in height and half an inch in diameter, a set of brown reinforcement bars measuring one-eighth of an inch in length, a set of white plastic mesh panels or fine copper mesh panels would be located on the bottom and the sides of the filter.

The plastic or the filter could be formed with the use of injection molding or blow molding. Injection molding is a process that has been used since the 1920s and provides a versatility almost unmatched in the mass production of any material. It requires that melted plastic be forcefully injected into relatively cool molds. As the plastic begins to harden, it takes on the shape of the mold cavity and when cool. requires few postmolding operations. Other advantages of this process include its speed of production and the ability to simultaneously manufacture multiple parts.

Blow molding in the production of plastic shapes is a form of extrusion, a major technique in the plastic industry. Extrusion is used to push a molten tube, called a parison, into a bottle-shaped mold. Compressed air then forces the parison against the cold walls of the mold, hence the term “blow molding”. Molds are generally side fed, with the thickness controlled by a tapered mandrel (core) or a variabe-orifice die. Continuous extrusion is possible by the use of multiple blow molds.

To use Filter Rite, one would place Filter Rite in a percolator coffee pot right over existing filter that comes with coffeemaker. This one is designed for a 1 to 12 cup capacity. When coffee was being made, the filter would collect grounds, filtering 100%, after use, Filter Rite could be removed from the coffee pot, allowed to cool, washed with soap and water and would be ready for reuse.

What I claim as my invention is:

1. Filter rite, a resuable percolater coffee filter providing innovative alternative to conventional coffee filters on the market today.
